(19) United States
(12) Patent Application Publication
(10) Pub. No.: US 2010/0053100 A1
(43) Pub. Date: Mar. 4, 2010

(54) Navigation Display System

(75) Inventors: Wen-Hsin Lin, Taipei (TW); Kuo-Chu Liao, Taipei (TW); Yi-Hao Syu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/504,892

(22) Filed: Jul. 17, 2009

(30) Foreign Application Priority Data
Sep. 1, 2008 (TW) 97133473

(51) Int. Cl. G06F 3/041; G09G 5/00; H04B 7/00

(52) U.S. Cl. 345/173; 345/7; 455/41.2

(57) ABSTRACT

A navigation display system includes a navigation device, a projection module and a remote-controlled module. The navigation device has a screen. The projection module is pivotally connected with and rotatable relative to the navigation device to project an image displayed on the screen onto a projection screen. The remote-controlled module is disposed on a direction steering unit of a vehicle to control the navigation device.

### RELATED APPLICATIONS

This application claims priority to Taiwan Application Serial Number 97133473, filed Sep. 1, 2008, which are herein incorporated by reference.

### BACKGROUND

1. Field of Invention

The present invention relates to a navigation system. More particularly, the present invention relates to a navigation display system.

2. Description of Related Art

A conventional palm-size navigation display system installed within a car is equipped with a screen, which is not large enough for the driver to comfortably see the navigation information. The reason why the palm-size navigation display system is designed with such small size is to permit the driver to conveniently take it away from the car after the car is parked. Thus, the navigation display system should not be large, and the screen on it would not possibly be large. For the forgoing reasons, there is a need for providing the driver a better and clearer navigation information.

### SUMMARY

It is therefore an objective of the present invention to provide a navigation display system.

In accordance with the foregoing and other objectives of the present invention, a navigation display system suitable for a vehicle is provided and has a navigation device, a projection module and a remote-controlled module. The navigation device has a screen. The projection module is pivotally connected with and rotatable relative to the navigation device to project a image displayed on the screen onto a projection screen. The remote-controlled module is disposed on a direction steering unit of the vehicle to control the navigation device.

Thus, the present invention provides a navigation display system to project the navigation formation properly and clearly with a rotatable projection module. In addition, the navigation display system also provides a remote-controlled module installed on direction steering unit, which is safe and convenient way for the driver. When the navigation formation is not needed, the navigation display system can be turned off with the remote-controlled module such that the driver can have a better view through the windshield for driving.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a navigation display system according to one embodiment of this invention; and

FIG. 2 illustrates a functional block diagram of the navigation display system according to one embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

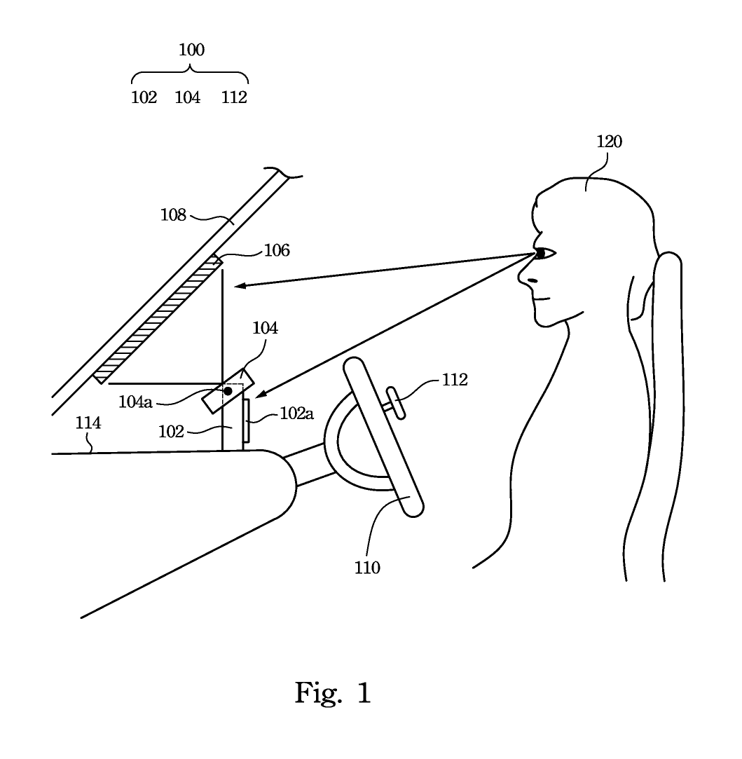

FIG. 1 illustrates a navigation display system according to one embodiment of this invention. The navigation display system 100 is installed in a vehicle, e.g. a car. The navigation display system 100 includes a navigation device 102, a projection module 104 and a remote-controlled module 112. In this embodiment, the navigation device 102 is installed within an area 114 between a windshield 108 and a direction steering unit 110 of the vehicle. The direction steering unit 110 can be a steering wheel. The projection module 104 is pivotally connected with the navigation device 102 by a hinge 104a such that the projection module 104 is rotatable relative to the navigation device 102 to project an image onto a projection screen. A driver in the vehicle can use the remote-controlled module 112 installed on the direction steering unit 110 to control the navigation device 102 or adjust a projection angle of the projection module 104.

The navigation device 102 can be a GPS (Global Positioning System) navigation device. The navigation device 102 has a screen 102a to show navigation information for the driver. The navigation device 102 can transmit data signal to the projection module 104 by a wired or wireless way. The projection module 104 is capable of projecting images, displayed on the screen 102a, onto the projection screen of bigger size (compared with the screen 102a) simultaneously such that the driver 120 can watch the navigation information comfortably.

In this embodiment, the projection screen can be the windshield 108 or a semi-transmissible/semi-reflective heat-isolating layer 106 attached on the windshield 108. The semi-transmissible/semi-reflective heat-isolating layer 106 has a better performance for the driver 120 to see the projected navigation information clearly. With this regard, the screen 102a and the windshield 108 can display the navigation information simultaneously such that two display options are provided for the driver 120 to choose. It should be noted that the windshields in different brand cars are arranged with different slanted angles, the projection module 104, installed on the navigation device 102, can project the navigation information clearly on the projection screen by fine tuning the projection angle to adapt different windshield designs.

The present embodiment also provides a safe and convenient way to simultaneously operate the direction steering unit 110 and the navigation device 102, that is, the remote-controlled module 112 is installed on the navigation device 102 for the driver 120 to operate. The screen 102a can be a touch-control screen for the driver 120 to operate easily. The remote-controlled module 112 also provides some basic operation buttons for the driver 120 to operate conveniently. The basic operation buttons on the remote-controlled module 112 may vary according to actual demands. The screen 102a and the remote-controlled module 112 are two operation interface options for the driver to choose according his or her needs. In this embodiment, the projection module 104 may be a liquid-crystal-on-silicon (LCOS) projection device.

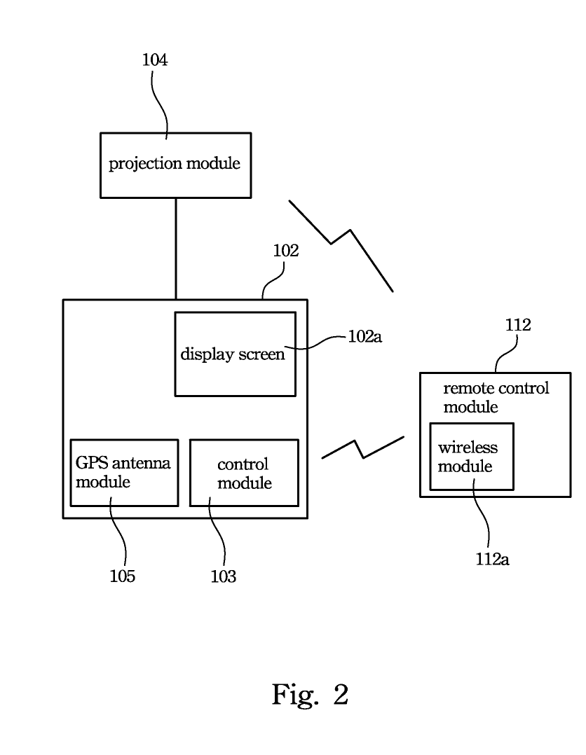

Referring to both FIG. 1 and FIG. 2, wherein FIG. 2 illustrates a functional block diagram of the navigation display system according to one embodiment of this invention. The navigation device 102 further includes a GPS antenna module 105 and a control module 103 in addition to the projection module 104 and the screen 102a. The GPS antenna module 105 receives a satellite signal and forwards the satellite signal to the control module 103. The control module 103 may consist of a processor, navigation application soft wares and etc., and computes the satellite signal from the GPS antenna module 105 to generate the navigation formation to be displayed on the screen 102a and projected on the projection screen. Alternately, the navigation formation may be merely displayed on the screen 102a alone or projected on the projection screen alone under control of the control module 103.

The control module 103 may receive control signals from the remote-controlled module 112, the screen 102a (a touch-control screen) or control buttons on the navigation device 102 to perform desired functions. The remote-controlled module 112 has a wireless module 112a to transmit control signals to the control module 103 so as to perform navigation related functions. In addition, the wireless module 112a may transmit control signals to the projection module 104 to adjust the projection angle. Alternately, the projection module 104 may also be controlled by the control module 103 to adjust the projection angle to obtain an optimum projection image, e.g. a clear projection image of proper size. The wireless module 112a can be a blue tooth wireless module, an infrared wireless module or other wireless module operated within ISM (Industrial, Scientific and Medical) radio bands.

The remote-controlled module 112 may also control the projection module 104 to switch between a continuous projection mode and a discontinuous projection mode. Any person skilled in the art may design related buttons on the remote-controlled module 112 according to demands and transmit signals to the control module 103 via the wireless module 112a to achieve the desired functions.

According to discussed embodiments, the present invention provides a navigation display system to project the navigation formation properly and clearly with a rotatable projection module. In addition, the navigation display system also provides a remote-controlled module installed on direction steering unit, which is safe and convenient way for the driver. When the navigation formation is not needed, the navigation display system can be turned off with the remote-controlled module such that the driver can have a better view through the windshield for driving.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A navigation display system suitable for a vehicle, the navigation display system comprising:
a navigation device having a screen;
a projection module being pivotally connected with and rotatable relative to the navigation device to project a image displayed on the screen onto a projection screen; and
a remote-controlled module disposed on a direction steering unit of the vehicle to control the navigation device.

2. The navigation display system of claim 1, wherein the projection screen is a windshield of the vehicle.

3. The navigation display system of claim 2, wherein the navigation device is disposed within an area between the direction steering unit and the windshield of the vehicle.

4. The navigation display system of claim 1, wherein the projection screen is larger than the screen in size.

5. The navigation display system of claim 1, wherein the remote-controlled module comprises a wireless module to transmit a control signal to the navigation device.

6. The navigation display system of claim 5, wherein the wireless module is a blue tooth wireless module or an infrared wireless module.

7. The navigation display system of claim 1, wherein the remote-controlled module is adapted to control the projection module.

8. The navigation display system of claim 1, wherein the projection module is a liquid-crystal-on-silicon (LCOS) projection device.

9. The navigation display system of claim 1, wherein the screen is a touch-control screen.
